(19) United States
(12) Patent Application Publication
(10) Pub. No.: US 2019/0011275 A1
(43) Pub. Date: Jan. 10, 2019

(54) SYSTEM AND METHOD FOR ROUTING AUTONOMOUS VEHICLES

(71) Applicants: Andrew Whinston, Austin, TX (US); Yixuan Liu, Austin, TX (US)

(72) Inventors: Andrew Whinston, Austin, TX (US); Yixuan Liu, Austin, TX (US)

(21) Appl. No.: 16/023,605

(22) Filed: Jun. 29, 2018

Related U.S. Application Data
(60) Provisional application No. 62/529,278, filed on Jul. 6, 2017.
(60) Provisional application No. 62/567,525, filed on Oct. 3, 2017.
(60) Provisional application No. 62/632,124, filed on Feb. 19, 2018.

(51) Int. Cl. G01C 21/34; G05D 1/00; G08G 1/01

(52) U.S. Cl. CPC G01C 21/3492; G05D 2201/0213; G08G 1/0129; G05D 1/0088

(57) ABSTRACT

A system for routing a vehicle includes a prediction module configured to receive traffic data in which the traffic data is communicated to the system via a wireless communication link. An information design engine is configured to receive a current traffic volume and a traffic prediction based on the traffic data from the prediction module and generate one or more route selection decisions for the vehicle in response to the traffic prediction. The one or more route selection decisions are provided to a vehicle control computer configured to control a vehicle steering system and a vehicle motion and braking system.

### CROSS-REFERENCE TO RELATED APPLICATIONS

This application claims the benefit of U.S. Provisional Application Ser. No. 62/529,278 filed Jul. 6, 2017 and titled “EFFICIENT REAL-TIME ROUTING FOR AUTONOMOUS VEHICLES”; U.S. Provisional Application Ser. No. 62/567,525 filed Oct. 3, 2017 and titled “ROUTING FOR HETEROGENEOUS AUTONOMOUS VEHICLES”; and U.S. Provisional Application Ser. No. 62/632,124 filed Feb. 19, 2018 and titled “ROUTING FOR HETEROGENEOUS AUTONOMOUS VEHICLES”. The provisional applications are incorporated by reference herein as if reproduced in full below.

### BACKGROUND

Many automobile drivers today rely on a crowdsourced traffic information service, such as WAZE®, to assist them in making routing decisions as they progress from their departure location to their destination location. These traffic information services provide near real-time information to the drivers with respect to traffic conditions on the roadways that link the driver's point of departure and destination. The information that these services provide is obtained by feedback from the vehicles pertaining to driving times as well as reports from the drivers. Drivers may then make informed decisions with respect to alternative route choices. With progress in autonomous vehicles is advancing rapidly the rapid appearance of such vehicles can be expected. Autonomous vehicles are already deployed as research vehicles and semi-autonomous vehicles with varying degrees of driver assistance are already commercially deployed. Fully autonomous vehicles in which the driver assumes a passive role, assuming control in emergency situations, are expected in the near future. Ultimately, autonomous vehicles without human drivers will appear. Autonomous vehicles relying on GPS and fixed waypoints between departure and destination will be subject to the same dynamic traffic conditions that human drivers try to mitigate by using crowdsourced traffic information services. Consequently, there is a need in the art for systems that leverage crowdsourced traffic information to provide dynamically adjusted routing decisions to the vehicle.

### BRIEF DESCRIPTION OF THE DRAWINGS

For a detailed description of exemplary embodiments of the invention, reference will now be made to the accompanying drawings in which:

FIG. 1 shows a data flow block diagram of a vehicle routing system in accordance with at least some embodiments;

FIG. 2 shows a data flow block diagram of a vehicle routing system in accordance with at least some embodiments;

FIG. 3 shows a schematic representation of a route selection task in accordance with at least some embodiments.

FIG. 4 shows a schematic representation of a route selection task in accordance with at least some embodiments;

FIG. 5 shows a schematic representation of a route selection task in accordance with at least some embodiments; and

FIG. 6 shows a flow chart of a method for determining a route selection decision in accordance with at least some embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

“Exemplary” as used herein means “serving as an example, instance, or illustration.” An embodiment described herein as “exemplary” is not necessarily to be construed as preferred or advantageous over other embodiments.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

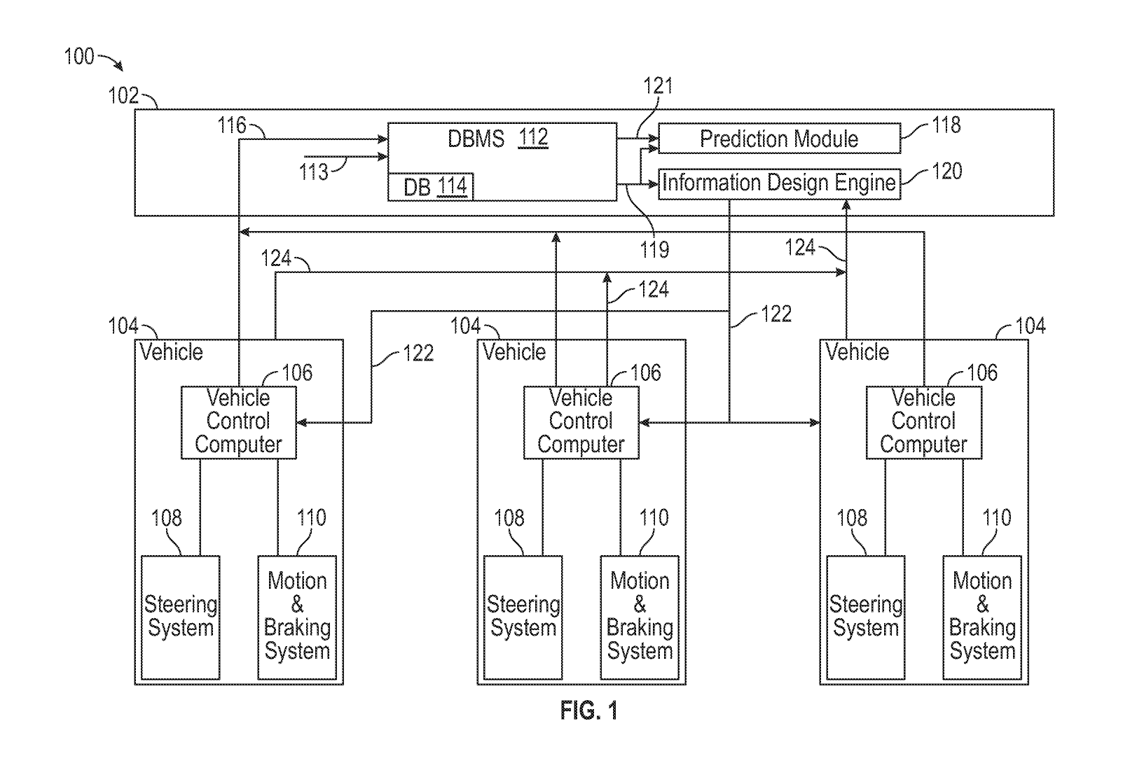

FIG. 1 shows a data flow block diagram of a vehicle routing system 100 in accordance with an exemplary embodiment. System 100 includes a server 102 that provides route selection decisions to a plurality of vehicles 104. Three vehicles 104 are shown for the purpose of illustration. It would be appreciated by those skilled in the art that a server 102 would be providing route selection decisions to perhaps several tens of vehicles 104. Further, a system 100 would comprise a farm of servers 102. Each vehicle 104 includes a vehicle control computer 106 coupled to a steering system 108 and a motion and brake system 110. Steering system 108 and motion and brake system 110 operate the steering, power and brake mechanisms of the vehicle (not shown in FIG. 1) as commanded by vehicle control computer 106. Thus, in this example embodiment, route selection decisions, as described further below, would be received by vehicle control computer 106, and along with position data from a vehicle Global Positioning System (not shown in FIG. 1) mapped into commands to steering system 108.

Server 102 includes a database management system (DBMS) 112 and a database (DB) 114. DB 114 holds both historic traffic data and real-time traffic data which may include crowdsourced traffic data 116. DBMS 112 manages DB 114 and provides traffic data, as described further below, to a prediction module 118 and to an information design engine 120. Additionally, DBMS 112 may receive weather data 113 from an external source which may also be provided to prediction module 118. An example of sources of weather data include GroundTruth® from WeatherCloud, Inc., Boulder, Colo. As described further below, prediction module 118 makes statistical predictions of the traffic on possible routes between a departure location and destination location of a vehicle 104. The predictions are based on both the real-time traffic data 119, e.g. current traffic volume, and historic traffic data and weather data 121 maintained in DB 114. The predictions are provided to information design engine 120. Further, in at least some embodiments, information design engine 120 may receive vehicle data 124 from vehicles 104. As described further below, such data may include vehicle type and toll budget information. As described further below, information design engine 120 generates route selection decisions 122 for each vehicle 104 and conveys them to the vehicles as vehicles 104 as they progress from their respective departure locations to destination locations. Stated otherwise, prediction module 118 is configured to receive traffic data which is communicated to system via a wireless communication link. Information design engine 120 is configured to receive current traffic volume and a traffic prediction based on the traffic data from the prediction module. Information design module 120 generates one or more route selection decisions for a vehicle 104 in response to the traffic prediction. The one or more route selection decisions are then provided to vehicle control computer 106 that is configured to control a vehicle steering system 108 and a vehicle motion and braking system 110. Because of workload demands in generating routing decisions, particularly in what amounts to substantially real time, information design engine 120 is instantiated in hardware, that is, as a hardware device. For example, in at least some embodiments, information design engine may be an application-specific integrated circuit (ASIC). Other instantiations may include a field-programmable gate array (FPGA), or similar devices. It would be understood by those skilled in the art that a server 102 includes other, conventional components such as central processing units (CPUs), memory, communication and network interfaces and the like that have not been shown in FIG. 1 so an not to obscure the descriptions in unnecessary detail inasmuch as such details are not necessary to obtain a complete understanding of the present invention and are within the skills of persons of ordinary skill in the relevant art. Likewise, it would be understood that interconnections between components in server 102, and between server 102 and vehicles 104 reflect logical interconnections and data transfer paths rather than a particular network or physical link architecture. Thus, interconnections may be instantiated by wired connections, wireless connections or combinations thereof. For example, routing selection decisions 122 may, in at least some embodiments be conveyed to vehicles 104 over a wireless communication link that is part of a cellular communication network. Likewise, vehicle data 124 may be sent to server 102 via a similar wireless link. However, it would be understood by those skilled in the art, that the principles disclosed herein do not depend on a particular wireless communication architecture or the particular data transport protocols employed thereon.

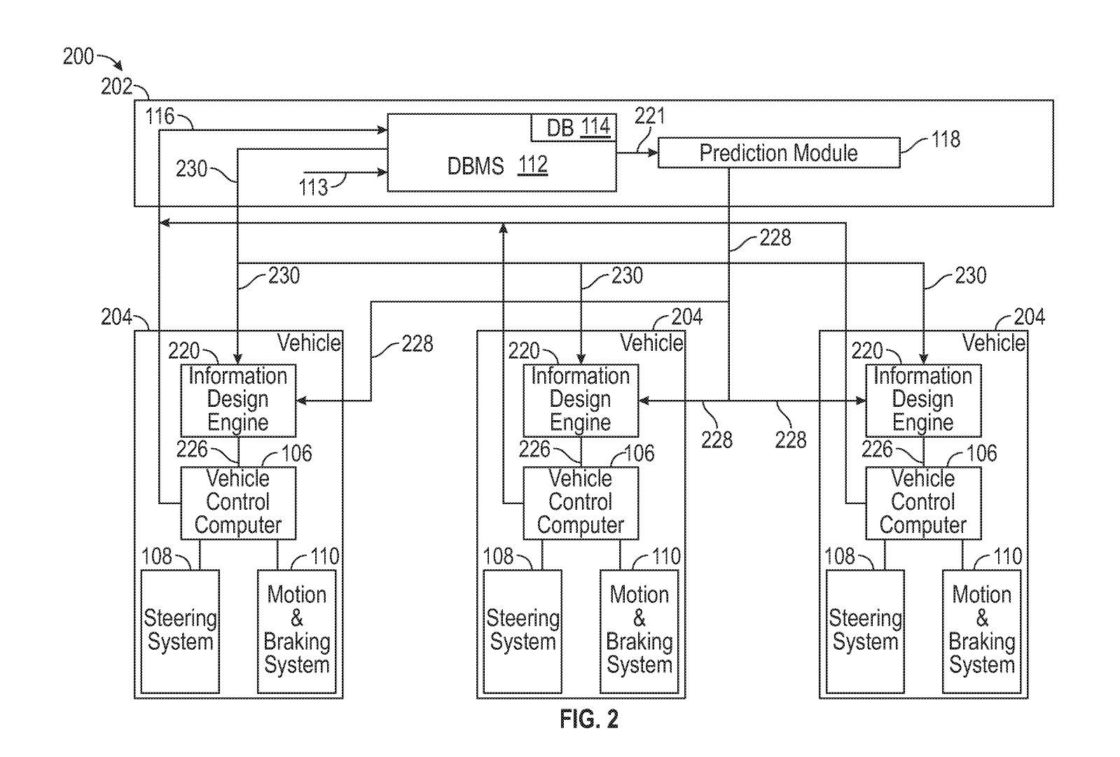

FIG. 2 shows a data flow block diagram of a vehicle routing system 200 in accordance with another exemplary embodiment. Similar to system 100, FIG. 1, system 200 includes a server 202 that provides route selection decisions to a plurality of vehicles 204. Three vehicles 204 are again shown for the purpose of illustration. Further, a system 200 would similarly comprise a farm of servers 202. Each vehicle 204 includes a vehicle control computer 106 coupled to a steering system 108 and a motion and brake system 110. Steering system 108 and motion and brake system 110 operate the steering, power and brake mechanisms of the vehicle (not shown in FIG. 2) as commanded by vehicle control computer 106. In system 200, each vehicle 204 includes an information design engine 220 coupled to a respective vehicle control computer 106. Server 202 does not include an information design engine. In this example embodiment, the determination of route selection decisions by an information design engine 220 are thus distributed among the vehicles 204 themselves, thereby reducing the workload imposed on an information design engine 220. Similar to information design engine 120, FIG. 1, information design engine 220 is instantiated in hardware, For example, in at least some embodiments, information design engine may be an application-specific integrated circuit (ASIC). Other instantiations may include a field-programmable gate array (FPGA), or similar devices. Further, in at least some embodiments, the ASIC or FPGA as the case may be may be integrated with vehicle control computer 106 on a single chip constituting a so-called System on a Chip (SOC) In an embodiment in which information design engine 220 and vehicle control computer 106 are discrete devices, route selection decisions 226 may be communicated to vehicle control computer 106 via a wired data link or bus. Route selection decisions 226 along with position data from a vehicle Global Positioning System (not shown in FIG. 2) would be mapped into commands to steering system 108 by vehicle control computer 106, similar to system 100, FIG. 1.

Similar to server 102, FIG. 1, server 202 includes a database management system (DBMS) 112 and a database (DB) 114. DB 114 holds both historic traffic data and real-time traffic data which may include crowdsourced traffic data 116. DBMS 112 manages DB 114 and provides traffic data, as described further below, to a prediction module 118 and to an information design engine 220. Similar to system 100, FIG. 1, DBMS 112 may receive weather data 113 from an external source which may also be provided to prediction module 118. As described above, prediction module 118 makes statistical predictions of the traffic on possible routes between a departure location and destination location of a vehicle 104. The traffic predictions are based on both the real-time traffic data 119, e.g. current traffic volume, and historic traffic data and weather data 121 maintained in DB 114. Traffic predictions 228 are provided to information design engine 220 via a wireless link, similar to the route selection decisions 122, FIG. 1. Further information design engine 220 road information 230, such as tolls and road capacities, from server 202 via a wireless link. In system 200, vehicle data may be loaded into each information design engine 220. The operation of information design engines 220 is otherwise the same as information design engines 120, FIG. 1, and it would be understood by those skilled in the art that the description hereinabove with respect to such operation also pertains to information design engines 220. It would also be understood by those skilled in the art that a server 202 includes other, conventional components such as central processing units (CPUs), memory, communication and network interfaces and the like that have not been shown in FIG. 2 so an not to obscure the descriptions in unnecessary detail inasmuch as such details are not necessary to obtain a complete understanding of the present invention and are within the skills of persons of ordinary skill in the relevant art. Likewise, as in system 100, FIG. 1, it would be understood that interconnections between components in server 202, and between server 202 and vehicles 204 reflect logical interconnections and data transfer paths rather than a particular network or physical link architecture. Thus, interconnections may be instantiated by wired connections, wireless connections or combinations thereof.

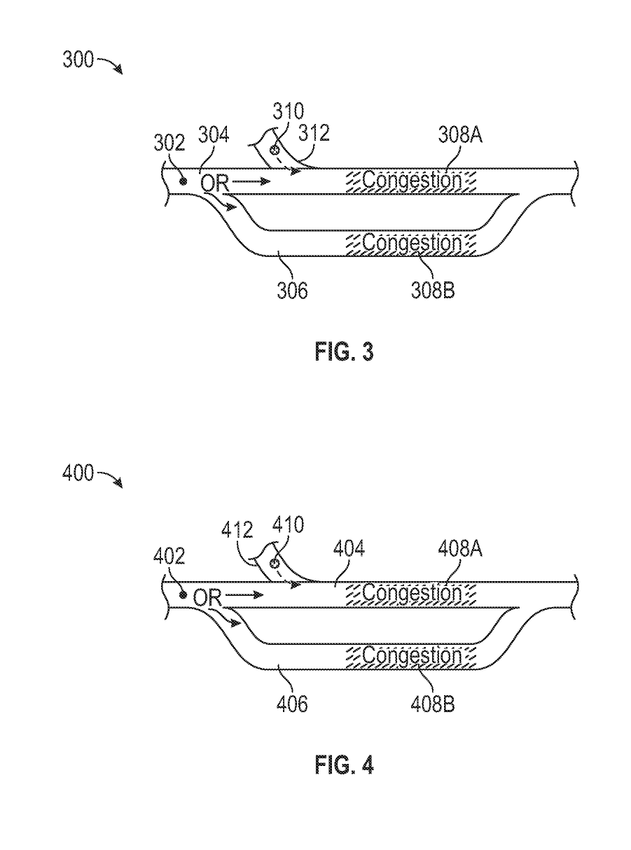

To further appreciate the principles of the disclosure, FIG. 3 shows a schematic representation of a route decision task 300 in accordance with an exemplary embodiment. In route decision task 300, a vehicle 302 has a choice between two routes: route 304 and route 306. Each route may have a different capacity to handle traffic which is accounted for by capacity s₁ on one of routes 304, 306 and a capacity s₂ on the other. With Each route may experience congestion 308A and 308B. Further, there is a possibility of merging traffic 310 entering one of the routes, in this example route 304, via an intersecting road 312. The state of merging traffic may be a random variable, θ, with a probability distribution of a number, θ=λ, of merging traffic 310 being ψ(λ). In at least some embodiments, the probability distribution ψ(λ) may be determined based on the real-time and historic traffic data by a prediction module 118 as described above in conjunction with FIGS. 1, 2. Note that the probability of no merging traffic 310 is 1−ψ. The congestion 308A on the route 304 is characterized by a queue length D₁ and the congestion 308B on route 306 by a queue length D₂. The values of D₁ and D₂ may be obtained from real-time crowdsourced traffic data as described above in conjunction with FIGS. 1, 2. An information design engine, e.g. 120, FIG. 1 or 220, FIG. 2, then determines a stochastic route selection decision by the minimization of the expected waiting time of vehicle 302:

$${min}_{p ( θ )} {𝔼}_{θ} [ ( \frac{{D}_{1} + θ}{{s}_{1}} ) p ( θ ) + ( \frac{{D}_{2}}{{s}_{2}} ) ( 1 - p ( θ ) ) ] \\ s . t . ( \frac{{D}_{1} + λ}{{s}_{1}} ) p ( λ ) ψ + ( \frac{{D}_{1}}{{s}_{1}} ) p ( 0 ) ( 1 - ψ ) \leq ( \frac{{D}_{2}}{{s}_{2}} ) p ( λ ) ψ + ( \frac{{D}_{2}}{{s}_{2}} ) p ( 0 ) ( 1 - ψ ) , \\ ( \frac{{D}_{2}}{{s}_{2}} ) ( 1 - p ( λ ) ) ψ + ( \frac{{D}_{2}}{{s}_{2}} ) ( 1 - p ( 0 ) ) ( 1 - ψ ) \leq ( \frac{{D}_{1} + λ}{{s}_{1}} ) ( 1 - p ( λ ) ) ψ + ( \frac{{D}_{1}}{{s}_{1}} ) ( 1 - p ( 0 ) ) ( 1 - ψ ) , \\ 0 \leq p ( θ ) \leq 1 , ∀ θ \qquad ( 1 )$$

where p(θ) is the probability that the routing decision is route 304, conditioned on the true state of the merging traffic 310 being θ E_{θ} is the expectation operator over the ensemble of merging traffic and min_{p(θ)} denotes minimum of the expected value. The probability that the routing decision is route 306 is 1−p(θ).

FIG. 4 shows a schematic representation of a route decision task 400 in accordance with another exemplary embodiment. In this embodiment, a vehicle 402 confronts a routing choice between a first route 404 and a second route 406. Further, one of the routes, say 406, is tolled, measured by the quantity, τ. The case of both routes being free in accounted for in the decision task as described further below by setting τ=0. Both routes are subject to congestion 408A, 408B represented by queue lengths D₀ and D₁, respectively. Again, there is a possibility of merging traffic 410 entering, in this example, the free route 404, via an intersecting road 412. Again, the state of merging traffic is a discrete random variable, θ, having a probability mass function (PMF) ƒ(θ). The PMF may, be determined based on historical traffic data by a prediction module 118 as previously described. As before, each route has a capacity, here denoted by capacity s₀ on free road 404 and a capacity s₁ on toll road 406. Further, in this exemplary embodiment, a vehicle 402 can have a private type, denoted by the quantity c, which is a measure of the disutility per unit time of delay. The higher the value of c, the tighter the schedule a vehicle 402 may have. In a system exemplified by system 100, FIG. 1, a vehicle 402's private type may be communicated to an information design engine 120 in vehicle data 124. A vehicle may choose to cheat and report a vehicle type c′ different from its true type. Because a vehicle may report a type other than its true type, from the perspective of the information design engine, the type, c is treated as a random variable with PMF g(c). The PMF g(c) is assigned by the vehicle owner or operator. With b, denoting the objective function of a vehicle 402 arriving at its destination, the utility function of a vehicle 402 is given in Equation (2):

$$u ( θ , c , a ) = \{ \begin{matrix}b - {ct}_{0} ( 0 ) , if a = 0 , \\ b - {ct}_{1} - τ , if a = 1.\end{matrix} \qquad ( 2 )$$

The utility function is also referred to as the payoff function. The quantity b is set by a vehicle owner or operator as a measure of the value it assigns to the trip from a starting point to a destination point. Thus the utility function or, equivalently the payoff function, is a measure of the value assigned to the trip diminished by the disutility arising from the delay, or waiting time, on a route, and further diminished by the toll on the toll road. Here t₀(θ) denotes the waiting time of a vehicle 402 if it travels on toll road 406 and t₁ denotes the waiting time if it travels on free road 404. Note that t₀ depends on the state of merging traffic inasmuch as the delay time would be expected to increase in the presence of merging traffic. Thus, the type, c weights the waiting time giving it more or less effect as the case may be in accordance with the tightness of the vehicle's schedule. With the probability of a toll road 406 routing decision denoted by τ(θ, c′) and a free road 404 routing decision given by 1−π(θ, c′). To optimize a route selection decision from the perspective of a vehicle 402, an information design engine minimized the total disutility from waiting times, as described further below, based on the ex post probability of taking toll road 406: a₀(1−π(θ, c′))+a₁π(θ, c′). Here a₀ and a1 represent vehicle actions with each taking values in {0,1}, where, if the vehicle takes follows the route selection decision to take toll road 406, a₀=0 and a₁=1, and vice versa if the vehicle does not follow the route selection decision. In other words, by basing the minimization on the aforesaid ex post probability, a vehicle has no incentive to ignore the route selection decision provided by the information design engine. Then, a vehicle 402's expected utility is, Equation (3):

U_{π}(c,c′,a₀,a₁)=Σ_{θϵΘ}u(θ,c,a₀(1−π(θ,c′))+a₁(π(θ,c′)))ƒ(θ) (3)

If a vehicle reports its true type and obeys the route selection decision, then c′=c, and a₀=0 and a₁=1. The utility is then U_{π}(c,c, 0, 1) which is hereinafter simply denoted by U_{π}(c). An information design engine, e.g. 120, FIG. 1 or 220, FIG. 2, then determines a stochastic route selection decision by the minimization of the expected disutility of vehicle 402:

min_{cϵC,θϵΘ}c[t₀(θ)+π(θ,c)(t₁−t₀(θ))]ƒ(θ)g(c)

s.t.U_{π}(c)≥U_{π}(c,c′,a₀,a₁),∀c,c′ϵC,∀a₀,a₁ϵA,π(θ,c)ϵ[0,1]. (4)

For example, an information design engine 120 (FIG. 1) or 220 (FIG. 2) may, in at least some embodiments, use a simplex method, or, alternatively, an interior point method in implementing this minimization.

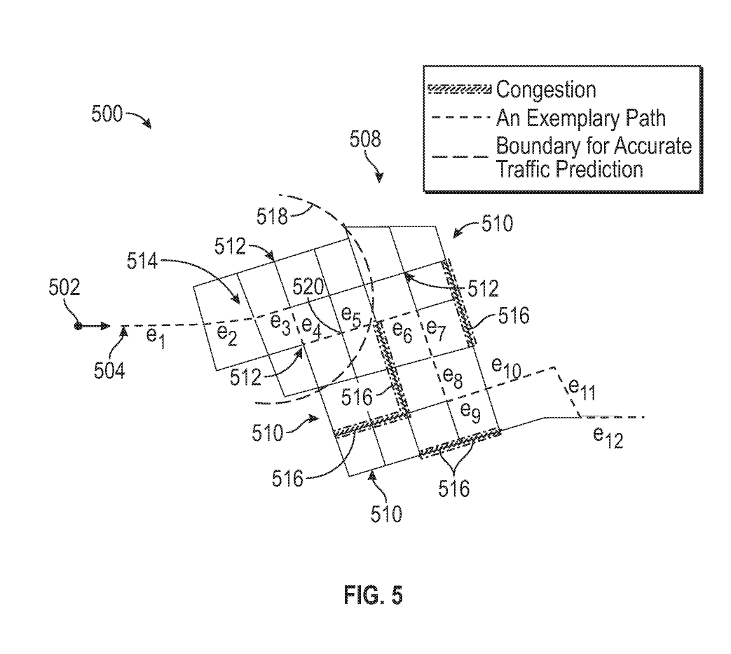

FIG. 5 shows a schematic representation of a route decision task 500 in accordance with yet another exemplary embodiment. In task 500, a vehicle 502 travels from a starting point 504 to a destination point 506 via a road network 508. A path from starting point 504 to destination point 506 comprises a set of road segments, defined by edges 510 and intersections 512 therebetween. An exemplary path 514 comprises edges, e₁, e₂, e₃, e₄, e₅, e₆, e₇, e₈, e₉, e₁₀, e₁₁ and e₁₂. Each edge 510 has a predetermined capacity, sₑ_{ᵢ}, where the index i runs from 1 to n, with n representing the total number of edges 510 in road network 508 connecting a starting point 504 to a destination point 506. Further, some edges 510 may experience congestion 516 of varying degrees (denoted by cross-hatching). A vehicle 502 departing from starting point 504 at a time, t, is informed of a queue length, denoted Dₑ(t) on each edge 510. As previously described, the queue lengths may comprise crowdsourced traffic data (e.g. crowdsourced traffic data 116, FIG. 1) and communicated to a vehicle 502 via a wireless link. However, beyond some boundary 518, accurate data may not be available and therefore in determining a route selection decision an information design engine regards the queue length as a random variable \tilde{D}_{E}=(\tilde{D}ₑ)_{eϵE} having a cumulative distribution function (CDF) \tilde{F} where E denotes the set of all edges 510 connecting starting point 504 and destination point 506. The travel time on the first edge, e₁ is given by Equation (5):

$${δ}_{{e}_{1}} = \frac{{D}_{{e}_{1}} + 1}{{s}_{{e}_{1}}} . \qquad ( 5 )$$

Then, the travel time in the iₜₕ edge, eᵢ where the index I runs from 2 to n is, Equation (6):

$${δ}_{{e}_{i}} = \frac{{\tilde{D}}_{{e}_{i}} ( t + {\sum }_{k = 1}^{i - 1} {δ}_{{e}_{k}} ) + 1}{{s}_{{e}_{i}}} , i = 2 , … , n . \qquad ( 6 )$$

And, the total travel time along a path, p, from starting point 504 to destination point 506, such as exemplary path 514 is thus, Equation (7):

δₚ=Σᵢ₌₁ⁿδₑ_{ᵢ} (7)

Further, at least some segments, i.e. edges, of a path may be tolled. Allowing for tolls to be dynamic, that is dependent on the level of congestion on the tolled segment, the total toll along path, p is given by Equation (8):

τₚ=Σᵢ₌₁ⁿ(t+Σₖ₌₁ⁱ⁻¹δₑ_{ₖ}). (8)

The utility function of a vehicle 502 is then, Equation (9):

u(\tilde{D}_{E},c,{aₚ}_{pϵP})=b−Σ_{pϵP}aₚ(cδₚ+τₚ). (9)

Here b is the utility of a vehicle 502 arriving at destination point 506 and where aₚ=1 if route p is chosen; otherwise aₚ=0. To further define the route selection decision mechanism of an information design engine, e.g. information design engine 120, FIG. 1 or 220 FIG. 2, the information design engine receives accurate traffic forecasts on the first Ĵ segments of route p. In other words, the information design engine receives a traffic prediction in the form of traffic forecasts on at least a portion of each path between a starting point 504 and destination point 506. For example, the information design engine may receive such traffic forecasts may be received from a prediction module 118, FIGS. 1, 2. With the realization of \tilde{D}_{E} denoted \hat{D}ₑ_{ⱼ} the expected utility is, Equation (10):

u(\tilde{D}_{E},c,{aₚ}_{pϵP})=b−Σ_{pϵP}aₚ(cδₚτₚ). (10)

where, as in task 400, FIG. 4, a vehicle 502's reported type is c′ which can be different that its true type, c, and

$${π}_{p} ( {\{ {\hat{D}}_{{e}_{j}} \}}_{1 \leq j \leq \hat{J}} , c )$$

is the probability that route p is selected given the accurate traffic flow forecast on the set of edges 510 given by {eⱼ}_{1≤j≤J}, vehicle 502's reported type, c. Similar to route selection task 400, FIG. 4, if a vehicle 502 reports its true type and obeys the route selection decision, the utility reduces to U_{π}(c, c, {p}_{pϵP}) which is simply denoted U_{π}(c). Similar to route selection task 400, FIG. 4, an information design engine, e.g. 120, FIG. 1 or 220, FIG. 2, determines a stochastic route selection decision by the minimization of the expected disutility of vehicle 502:

$$min {𝔼}_{c} [ {𝔼}_{{\tilde{D}}_{E}} [ {π}_{p} ( {\{ {\hat{D}}_{{e}_{j}} \}}_{1 \leq j \leq \hat{J}} , c ) {δ}_{p} ] ] \\ s . t . {U}_{π} ( c ) \geq {U}_{π} ( c , {c}^{′} , {\{ {p}^{′} ( p ) \}}_{p ∈ P} ) ∀ c , {c}^{′} ∈ C , ∀ {p}^{′} , \\ {Σ}_{p ∈ P} {π}_{p} ( {\{ {\hat{D}}_{{e}_{j}} \}}_{1 \leq j \leq \hat{J}} , c ) = 1 , \\ {π}_{p} ( {\{ {\hat{D}}_{{e}_{j}} \}}_{1 \leq j \leq \hat{J}} , c ) \geq 0. \qquad ( 11 )$$

Further, as a trip may pass several toll segments, an owner or occupant of an autonomous vehicle may, in at least some embodiments, want to specify a toll budget for the trip. In such an embodiment the individual rationality constraint is replaced by a budget constraint:

$$B - {𝔼}_{{\tilde{D}}_{E}} [ {Σ}_{p ∈ P} {π}_{p} ( {\{ {\hat{D}}_{{e}_{j}} \}}_{1 \leq j \leq \hat{J}} , c ) {a}_{p} {τ}_{p} ] \geq 0. \qquad ( 12 )$$

Here B denotes the budget set by the owner or occupant. In such an embodiment, an information design engine determines the route selection decision in accordance with the following constrained disutility minimization:

$$min {𝔼}_{c} [ {𝔼}_{{\tilde{D}}_{E}} [ {π}_{p} ( {\{ {\hat{D}}_{{e}_{j}} \}}_{1 \leq j \leq \hat{J}} , c ) {δ}_{p} ] ] \\ s . t . {U}_{π} ( c ) \geq {U}_{π} ( c , {c}^{′} , {\{ {p}^{′} ( p ) \}}_{p ∈ P} ) ∀ c , {c}^{′} ∈ C , ∀ {p}^{′} , \\ B - {𝔼}_{{\tilde{D}}_{E}} [ {Σ}_{p ∈ P} {π}_{p} ( {\{ {\hat{D}}_{{e}_{j}} \}}_{1 \leq j \leq \hat{J}} , c ) {a}_{p} {τ}_{p} ] \geq 0 , ∀ c ∈ C . \qquad ( 13 )$$

In this way, route selection decisions are constrained to keep the total toll expense under the set budget, B. Although the foregoing example is described in terms of a route selection between a particular starting point 504 and destination point 506, it would be appreciated by those skilled in the art having the benefit of the disclosure that an intermediate intersection, e.g. intersection 520, may itself be treated as a destination point, and the route selection decision refined by an information design engine by re-optimizing the selection by treating the intermediate intersection, e.g. 520, as a new starting point with updated traffic data forecasts on the segments connecting the intermediate intersection 520 and the destination point 506. It would be further appreciated that such re-optimization could be repeated as updated traffic forecasts were provided to the information deign engine by a prediction module, for example.

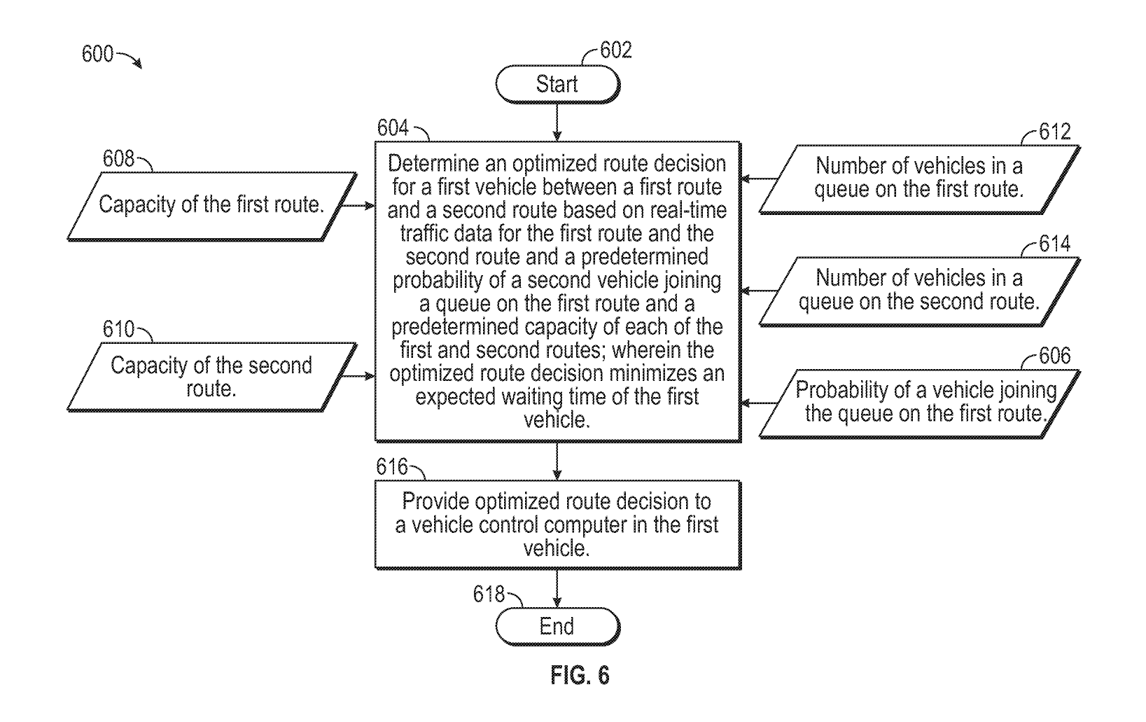

FIG. 6 is a flowchart of a method 600 for providing routing decisions to a vehicle. Method 600 starts at block 602. In block 604, an optimized route decision for a first vehicle between a first route and a second route is determined. The route decision is based on real-time traffic data for the first route and the second route. The route decision is also based on a predetermined probability of a vehicle joining a queue on the first route, input at block 606, and a predetermined capacity of each of the first and second routes, input at blocks 608, 610, respectively. Real-time traffic data comprising a number of vehicles in the queue on the first route is input at block 612. Real-time traffic data comprising a number of vehicles in a queue on the second route is input at block 614. The optimized route decision minimizes an expected waiting time of the first vehicle. In block 616, the optimized route decision is provided to a vehicle control computer in the first vehicle. Method 600 ends at block 618. In at least some embodiments, the predetermined probability of a second vehicle joining the queue is determined by a prediction module based on historic traffic data. Further, in at least some embodiments, the predetermined probability is sent to an information design engine in the first vehicle via a wireless communication link.

TABLE I
Table I summarizes the symbols used hereinabove.

| | |
|---|---|
| τ | The fee paid to use the toll road |
| s₀ | The capacity of the free road |
| s₁ | The capacity of the toll road |
| A = {0, 1} | The action set. 0 denotes taking the free road; 1 denoted taking the toll |
| | road |
| α | An action in the action set |
| D₀ | The number of vehicles on the free road when the vehicle departs |
| D₁ | The number of vehicles on the toll road when the vehicle departs |
| Θ | The set of possible number of merging vehicles |
| θ | A possible number of merging vehicles |
| f (θ) | The probability that a number of θ vehicles merging into the free road |
| t₀ | The vehicle's waiting time if it travels on the toll road |
| t₁ | The vehicle's waiting time if it travels on the free road |
| u | The utility function of the vehicle |
| b | The utility of arriving at the destination from the starting point |
| c | The disutility from per unit time of waiting (delay) |
| g (c) | The probability that a vehicle has disutility c |
| π (θ, c) | The probability that the information designer recommends the toll road |
| | under θ and vehicle's reported c |
| U_{π} | The expected utility of a vehicle under the recommendation π |
| p = (e₁, . . . , eₙ) | A path p that goes through roads e₁, . . . , eₙ |
| Dₑ (t) | The current traffic volume (queue length) on the road e |
| δₑ | The travel time on the road e |
| δₚ | The travel time on the path p |
| [symbol] _{θ} | The operator of taking expectation |
| [symbol] | The set of all real numbers |
| B | Budget |
| s.t. | Such that |
| ∀ | For all |
| ∈ | Element of |
| min | Minimize |
| max | Maximize |
| inf | Infimum or greatest lower bound |

The above discussion is meant to be illustrative of the principles and various embodiments of the present invention. Numerous variations and modifications will become apparent to those skilled in the art once the above disclosure is fully appreciated. For example, an information design engine may base a route selection decision on the departure of multiple vehicles from a starting point. In other embodiments, an information design engine may base a route selection decision on the departure of multiple vehicles at different starting times. It is intended that the following claims be interpreted to embrace all such variations and modifications.

What is claimed is:

1. A system for routing a vehicle comprising:
a prediction module configured to receive traffic data wherein the traffic data is communicated to the system via a wireless communication link;
an information design engine configured to a receive current traffic volume and a traffic prediction based on the traffic data from the prediction module and generate one or more route selection decisions for the vehicle in response to the traffic prediction; wherein the one or more route selection decisions are provided to a vehicle control computer configured to control a vehicle steering system and a vehicle motion and braking system.

2. The system of claim 1 wherein the information design engine generates the route selection decisions based on a minimization of an expected value of the travel time over each path between a starting point and a destination point of the vehicle.

3. The system of claim 2 wherein the traffic prediction includes a forecast of traffic on at least a portion of each path between the starting point and the destination point of the vehicle.

4. The system of claim 3 wherein:
the prediction module is further configured to receive weather data; and
wherein the traffic forecast is received from the prediction module and additionally based on the weather data.

5. The system of claim 2 wherein:
at least a portion of a path comprises a toll road; and
the minimization of the expected value is subject to a budget constraint.

6. The system of claim 1 wherein the information design engine comprises a field programmable gate array (FPGA) or an application specific integrated circuit (ASIC).

7. The system of claim 6 wherein the information design engine is disposed within the vehicle and coupled to a vehicle control computer configured to control a vehicle steering system and a vehicle motion and braking system.

8. The system of claim 7 wherein the traffic prediction is sent to the information design engine via a wireless communication link.

9. The system of claim 1 wherein the route selection decision is further based on a reported vehicle type.

10. The system of claim 1 wherein:
routes between a starting point and a destination point of the vehicle comprise a toll road and a free road; and
the information design engine generates one or more route selection decisions comprising a decision between the toll road and the free road such that the vehicle reports its true type and obeys the decision.

11. The system of claim 1 wherein:
the route selection decision comprises an optimized route decision between a first route and a second route; and
the route selection decision is based on:
real-time traffic data for the first route and real-time traffic data for the second route; the real-time traffic data for the first route comprising:
a number of vehicles in a queue on the first route and the real-time traffic data for the second route comprising a number of vehicles in a queue on the second route;
a probability of a vehicle joining the queue on the first route, the probability received from the prediction module; and
a predetermined capacity of each of the first and second routes; and
the optimized route decision minimizes an expected waiting time of the vehicle.

12. The system of claim 1 wherein the route selection decisions are sent to the vehicle control computer via a wireless communication link.

13. The system of claim 1 wherein the traffic prediction is based on a predetermined probability distribution of queue length on each route between a start location of the vehicle and a destination of the vehicle.

14. The system of claim 13 wherein the predetermined probability distribution is determined by the prediction module based on historical traffic data.

15. A method for routing a vehicle comprising:
determining an optimized route decision for a first vehicle between a first route and a second route, wherein:
the decision is based on:
real-time traffic data for the first route and real-time traffic data for the second route;
a predetermined probability of a second vehicle joining a queue on the first route; and
a predetermined capacity of each of the first and second routes;
the optimized route decision minimizes an expected wait time of the first vehicle; and
providing the optimized route decision to a vehicle control computer.

16. The method of claim 15 wherein the predetermined probability of a second vehicle joining the queue is determined by the prediction module based on historical traffic data.

17. The method of claim 15 wherein the predetermined probability is sent to the first vehicle via a wireless communication link.

18. The method of claim 15 wherein the real-time traffic data for the first route comprises a number of vehicles in the queue on the first route and the real-time traffic data for the second route comprises a number of vehicles in a queue on the second route.
